(19) United States
(12) Patent Application Publication
(10) Pub. No.: US 2004/0157745 A1
(43) Pub. Date: Aug. 12, 2004

(54) Oil-based suspension concentrates

(76) Inventors: Ronald Vermeer, Leverkusen (DE); Peter Baur, Eppstein (DE); Frank Rosenfeldt, Langenfeld (DE)

Correspondence Address: Bayer CropScience, Patent Department, 100 Bayer Road, Pittsburgh, PA, 15205-9741, US

(21) Appl. No.: 10/480,945

(22) PCT Filed: Jun. 10, 2002
(86) PCT No.: PCT/EP02/06323

(30) Foreign Application Priority Data
Jun. 21, 2001 (DE) 101 29 855.2

(51) Int. Cl. A01N 25/02; A01N 43/00

(52) U.S. Cl. 504/362; 504/129

(57) ABSTRACT

This invention relates to new oil-based suspension concentrates containing

at least one agrochemical active compound which is solid at room temperature,

at least one penetration promoter,

at least one vegetable oil,

one or more non-ionic surfactants or dispersing aids and/or one or more anionic surfactants or dispersing aids and

optionally one or more additives selected from the group consisting of emulsifying agents, antifoam agents, preservatives, antioxidants, colorants and/or inert filling materials,

to a process for the preparation of these suspension concentrates and to their use for the application of the active compounds contained therein.

The present invention relates to new, oil-based suspension concentrates of agrochemical active compounds, a process for the preparation of these formulations and their use for the application of the active compounds contained.

Numerous anhydrous suspension concentrates of agrochemical active compounds have already been disclosed. Thus, EP-A 0 789 999 describes formulations of this type which, in addition to active compound and oil, contain a mixture of various surfactants, —among them also those which serve as penetration promoters—, and a hydrophobized alumo-layer silicate as a thickening agent. The stability of these preparations is good. It is disadvantageous, however, that a thickening agent is compulsorily present, because the preparation is more complicated on account of this. Moreover, the thickening agent in each case absorbs some of the amount of penetration promoter added, which is therefore not available for its real function.

Furthermore, U.S. Pat. No. 6,165,940 already discloses non-aqueous suspension concentrates in which, apart from agrochemical active compound, penetration promoter and surfactant or surfactant mixture, an organic solvent is present, suitable solvents of this type also being paraffin oil or vegetable oil esters. The biological activity and the stability of the spray liquors which can be prepared from these formulations by diluting with water, however, is not always adequate.

New oil-based suspension concentrates have now been found, which consist of

at least one agrochemical active compound which is solid at room temperature,

at least one penetration promoter,

at least one vegetable oil,

at least one non-ionic surfactant or dispersing aid and/or at least one anionic surfactant or dispersing aid and

optionally one or more additives from the group consisting of the emulsifying agents, the antifoam agents, the preservatives, the antioxidants, the colourants and/or the inert filling materials.

It has furthermore been found that the oil-based suspension concentrates according to the invention can be prepared by mixing

at least one agrochemical active compound which is solid at room temperature,

at least one penetration promoter,

at least one vegetable oil,

at least one non-ionic surfactant or dispersing aid and/or at least one anionic surfactant or dispersing aid and

optionally one or more additives from the groups consisting of the emulsifying agents, the antifoam agents, the preservatives, the antioxidants, the colourants and/or the inert filling materials

with one another and then optionally grinding the resulting suspension.

Finally, it has been found that the oil-based suspension concentrates according to the invention are very highly suitable for the application of the agrochemical active compounds contained to plants and/or their habitat.

It is to be indicated as extremely surprising that the oil-based suspension concentrates according to the invention have a very good stability, although they contain no thickening agent. It is also unexpected that they exhibit a markedly better biological activity than the previously known formulations having the most similar composition. Otherwise, the oil-based suspension concentrates according to the invention, with respect to their activity, surprisingly also excel analogous preparations which, in addition to the other components, contain either only penetration promoter or only vegetable oil. Such a synergistic effect could not be foreseen on the basis of the prior art described above.

The oil-based suspension concentrates according to the invention are also distinguished by a number of advantages. Thus their preparation is less complicated than the preparation of corresponding formulations in which thickening agents are present. It is furthermore advantageous that on diluting the concentrates according to the invention with water neither a significant formation of cream nor a troublesome formation of flocks occurs, which is frequently the case with corresponding previously known preparations. Finally, the formulations according to the invention favour the biological activity of the active components contained, so that in comparison to conventional preparations either a higher activity is achieved or less active compound is necessary.

Solid, agrochemical active compounds are to be understood in the present composition as meaning all substances customary for plant treatment, whose melting point is above 20° C. Fungicides, bactericides, insecticides, acaricides, nematicides, molluscicides, herbicides, plant growth regulators, plant nutrients and repellents may preferably be mentioned.

Examples of fungicides which may be mentioned are:

2-anilino-4-methyl-6-cyclopropyl-pyrimidine; 2′,6′-dibromo-2-methyl-4′-trifluoro-methoxy-4′-trifluoromethyl-1,3-thiazole-5-carboxanilide; 2,6-dichloro-N-(4-trifluoro-methylbenzyl)-benzamide; (E)-2-methoximino-N-methyl-2-(2-phenoxyphenyl)-acetamide; 8-hydroxyquinoline sulphate; methyl (E)-2-{2-[6-(2-cyanophenoxy)-pyrimidin-4-yloxy]-phenyl}-3-methoxyacrylate; methyl (E)-methoximino[alpha-(o-tolyloxy)-o-tolyl]-acetate; 2-phenylphenol (OPP), aldimorph, ampropylfos, anilazine, azaconazole,

benalaxyl, benodanil, benomyl, binapacryl, biphenyl, bitertanol, blasticidin-S, bromuconazole, bupirimate, buthiobate,

calcium polysulphide, captafol, captan, carbendazim, carboxin, quinomethionate, chloroneb, chloropicrin, chlorothalonil, chlozolinate, cufraneb, cymoxanil, cyproconazole, cyprofuram, carpropamide,

dichlorophen, diclobutrazole, dichlofluanid, diclomezin, dicloran, diethofencarb, difenoconazole, dimethirimol, dimethomorph, diniconazole, dinocap, diphenylamine, dipyrithion, ditalimfos, dithianon, dodine, drazoxolon,

edifenphos, epoxyconazole, ethirimol, etridiazole,

fenarimol, fenbuconazole, fenfuram, fenitropan, fenpiclonil, fentin acetate, fentin hydroxide, ferbam, ferimzone, fluazinam, fludioxonil, fluoromide, fluquinconazole, flusilazole, flusulfamide, flutolanil, flutriafol, folpet, fosetyl-aluminium, fthalide, fuberidazole, furalaxyl, firmecyclox, fenhexamide,

guazatine,

hexachlorobenzene, hexaconazole, hymexazole,

imazalil, imibenconazole, iminoctadine, iprobenfos (IBP), iprodion, isoprothiolan, iprovalicarb,

kasugamycin, copper preparations, such as: copper hydroxide, copper naphthenate, copper oxychloride, copper sulphate, copper oxide, oxine-copper and Bordeaux mixture,

mancopper, mancozeb, maneb, mepanipyrim, mepronil, metalaxyl, metconazole, methasulfocarb, methfuroxam, metiram, metsulfovax, myclobutanil,

nickel dimethyldithiocarbarnate, nitrothal-isopropyl, nuarimol,

ofurace, oxadixyl, oxamocarb, oxycarboxine,

pefurazoate, penconazole, pencycuron, phosdiphen, pimaricin, piperalin, polyoxine, probenazole, prochloraz, procymidon, propamocarb, propiconazole, propineb, pyrazophos, pyrifenox, pyrimethanil, pyroquilon,

quintozene (PCNB), quinoxyfen,

sulphur and sulphur preparations,

tebuconazole, tecloftalam, tecnazene, tetraconazole, thiabendazole, thicyofen, thiophanate-methyl, thiram, toldlophos-methyl, tolylfluanid, triadimefon, triadimenol, triazoxide, trichlamide, tricyclazole, tridemorph, triflumizole, triforin, triticonazole, trifloxystrobin,

validamycin A, vinclozolin,

zineb, ziram and

2-[2-(1-chloro-cyclopropyl)-3-(2-chlorophenyl)-2-hydroxypropyl]-2,4-dihydro-[1,2,4]-triazole-3-thione.

Examples of bactericides which may be mentioned are:

bronopol, dichlorophen, nitrapyrin, nickel dimethyldithiocarbamate, kasugamycin, octhilinon, furancarboxylic acid, oxytetracycline, probenazole, streptomycin, tecloftalam, copper sulphate and other copper preparations.

Examples of insecticides, acaricides and nematicides which may be mentioned are:

abamectin, acephate, acrinathrin, alanycarb, aldicarb, alphamethrin, amitraz, avermectin, AZ 60541, azadirachtin, azinphos A, azinphos M, azocyclotin,

Bacillus thuringiensis, 4-bromo-2-(4-chlorphenyl)-1-(ethoxymethyl)-5-(trifluoromethyl)-1H-pyrrole-3-carbonitrile, bendiocarb, benfuracarb, bensultap, betacyfluthrin, bifenthrin, BPMC, brofenprox, bromophos A, bufencarb, buprofezin, butocarboxine, butylpyridaben,

cadusafos, carbaryl, carbofuran, carbophenothion, carbosulfan, cartap, chloethocarb, chloretoxyfos, chlorfenvinphos, chlorfluazuron, chlormephos, N-[(6-chloro-3-pyridinyl)-methyl]-N′-cyano-N-methyl-ethaneimidamide, chlorpyrifos, chlorpyrifos M, cis-resmethrin, clocythrin, clofentezin, cyanophos, cycloprothrin, cyfluthrin, cyhalothrin, cyhexatin, cypermethrin, cyromazin,

deltamethrin, demeton-M, demeton-S, demeton-S-methyl, diafenthiuron, diazinon, dichlofenthion, dichlorvos, dicliphos, dicrotophos, diethion, diflubenzuron, dimethoate,

dimethylvinphos, dioxathion, disulfoton,

emamectin, esfen valerate, ethiofencarb, ethion, ethofenprox, ethoprophos, etrimphos,

fenamiphos, fenazaquin, fenbutatin oxide, fenitrothion, fenobucarb, fenothiocarb, fenoxycarb, fenpropathrin, fenpyrad, fenpyroximate, fenthion, fenvalerate, fipronil, fluazuron, flucycloxuron, flucythrinate, flufenoxuron, flufenprox, fluvalinate, fonophos, formothion, fosthiazate, fubfenprox, furathiocarb,

HCH, heptenophos, hexaflumuron, hexythiazox,

imidacloprid, iprobenfos, isazophos, isofenphos, isoprocarb, isoxathion, ivermectin, lambda-cyhalothrin, lufenuron,

malathion, mecarbam, mevinphos, mesulfenphos, metaldehyde, methacrifos, methamidophos, methidathion, methiocarb, methomyl, metolcarb, milbemectin, monocrotophos, moxidectin,

naled, NC 184, nitenpyram,

omethoate, oxamyl, oxydemethon M, oxydeprofos,

parathion A, parathion M, permethrin, phenthoate, phorate, phosalon, phosmet, phosphamidon, phoxim, pirimicarb, pirimiphos M, pirimiphos A, profenophos, promecarb, propaphos, propoxur, prothiophos, prothoate, pymetrozine, pyrachlophos, pyridaphenthion, pyresmethrin, pyrethrum, pyridaben, pyrimidifen, pyriproxifen,

quinalphos,

salithion, sebufos, silafluofen, sulfotep, sulprofos,

tebufenozide, tebufenpyrad, tebupirimiphos, teflubenzuron, tefluthrin, temephos, terbam, terbufos, tetrachlorvinphos, thiacloprid, thiafenox, thiamethoxam, thiodicarb, thiofanox, thiomethon, thionazine, thuringiensin, tralomethrin, transfluthrin, triarathen, triazophos, triazuron, trichlorfon, triflumuron, trimethacarb,

vamidothion, XMC, xylylcarb, zetamethrin.

Examples of molluscicides which may be mentioned are metaldehyde and methiocarb.

Examples of herbicides which may be mentioned are:

anilides, such as, for example, diflufenican and propanil; arylcarboxylic acids, such as, for example, dichlorpicolinic acid, dicamba and picloram; aryloxyalkanoic acids, such as, for example, 2,4-D, 2,4-DB, 2,4-DP, fluroxypyr, MCPA, MCPP and triclopyr; aryloxy-phenoxy-alkanoic acid esters, such as, for example, diclofop-methyl, fenoxaprop-ethyl, fluazifop-butyl, haloxyfop-methyl and quizalofop-ethyl; azinones, such as, for example, chloridazon and norflurazon; carbamates, such as, for example, chlorpropham, desmedipham, phenmedipham and propham; chloroacetanilides, such as, for example, alachlor, acetochlor, butachlor, metazachlor, metolachlor, pretilachlor and propachlor; dinitroarilines, such as, for example, oryzalin, pendimethalin and trifluralin; diphenyl ethers, such as, for example, acifluorfen, bifenox, fluoroglycofen, fomesafen, halosafen, lactofen and oxyfluorfen; ureas, such as, for example, chlortoluron, diuron, fluometuron, isoproturon, linuron and methabenzthiazuron; hydroxylamines, such as, for example, alloxydim, clethodim, cycloxydim, sethoxydim and tralkoxydim; imidazolinones, such as, for example, imazethapyr, imazamethabenz, imazapyr and imazaquin; nitriles, such as, for example, bromoxynil, dichlobenil and ioxynil; oxyacetamides, such as, for example, mefenacet; sulphonylureas, such as, for example, amidosulfuron, bensulfuron-methyl, chlorimuron-ethyl, chlorsulfuron, cinosulfuron, metsulfuron-methyl, nicosulfuron, primisulfuron, pyrazosulfuron-ethyl, thifensulfuron-methyl, triasulfuron and tribenuron-methyl; thiocarbamates, such as, for example, butylate, cycloate, diallate, EPTC, esprocarb, molinate, prosulfocarb, thiobencarb and triallate; triazines, such as, for example, atrazine, cyanazine, simazine, simetryne, terbutryne and terbutylazine; triazinones, such as, for example, hexazinon, metamitron and metribuzin; others, such as, for example, aminotriazole, benfuresate, bentazone, cinmethylin, clomazone, clopyralid, difenzoquat, dithiopyr, ethofumesate, fluorochloridone, glufosinate, glyphosate, isoxaben, pyridate, quinchlorac, quinmerac, sulphosate and tridiphane. In addition, 4-amino-N-(1,1-dimethylethyl)-4,5-dihydro-3-(1-methylethyl)-5-oxo-1H-1,2,4-triazole-1-carboxamide and 2-((((4,5-dihdydro-4-methyl-5-oxo-3-propoxy-1H-1,2,4-triazol-1-yl)carbonyl)amino)sulfonyl) methyl benzoate may be mentioned.

Examples of plant growth regulators which may be mentioned are chlorocholine chloride and ethephon.

Examples of plant nutrients which may be mentioned are customary inorganic or organic fertilizers for supplying plants with macro- and/or micronutrients.

Examples of repellents which may be mentioned are diethyl-tolylamide, ethylhexane-diol and buto-pyronoxyl.

Suitable penetration promoters in the present composition are all those substances which are customarily employed in order to improve the penetration of agrochemical active compounds into plants. Alkanol alkoxylates of the formula

R—O-(-AO)ₘH (I)

in which

R represents straight-chain or branched alkyl having 4 to 20 carbon atoms,

AO represents an ethylene oxide radical, a propylene oxide radical, a butylene oxide radical, or mixtures of ethylene oxide and propylene oxide radicals or butylene oxide radicals and

m represents numbers from 2 to 30,

are preferred.

A particularly preferred group of penetration promoters are alkanol alkoxylates of the formula

R—O-(-EO—)ₙ—H (Ia)

in which

R has the meaning indicated above,

EO represents —CH₂—CH₂—O— and

n represents numbers from 2 to 20.

A further particularly preferred group of penetration promoters are alkanol alkoxylates of the formula

R—O-(-EO—)ₚ—(—PO—)_{q}—H (Ib)

in which

R has the meaning indicated above,

EO represents —CH₂—CH₂—O—,

PO represents

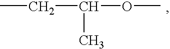

p represents numbers from 1 to 10 and

q represents numbers from 1 to 10.

A further particularly preferred group of penetration promoters are alkanol alkoxylates of the formula

R—O—(—PO—)ᵣ-(EO—)ₛ—H (Ic)

in which

R has the meaning indicated above,

EO represents —CH₂—CH₂—O—,

PO represents

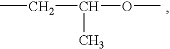

r represents numbers from 1 to 10 and

s represents numbers from 1 to 10.

A further particularly preferred group of penetration promoters are alkanol alkoxylates of the formula

CH₃—(CH₂)ₜ—CH₂—O—(—CH₂—CH₂—O—)ᵤ—H (Id)

in which

t represents numbers from 8 to 13 and

u represents numbers from 6 to 17.

In the formulae indicated beforehand

R preferably represents butyl, i-butyl, n-pentyl, i-pentyl, neopentyl, n-hexyl, i-hexyl, n-octyl, i-octyl, 2-ethyl-hexyl, nonyl, i-nonyl, decyl, n-dodecyl, i-dodecyl, lauryl, myristyl, i-tridecyl, trimethyl-nonyl, palnityl, stearyl or eicosyl.

An example of an alkanol alkoxylate of the formula (1c) which may be mentioned is 2-ethyl-hexyl alkoxylate of the formula

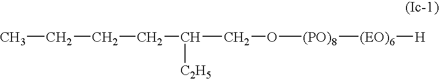

in which

EO represents —CH₂—CH₂—O—,

PO represents

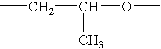

and the numbers 8 and 6 are average values.

Particularly preferred alkanol alkoxylates of the formula (Id) are compounds of this formula in which

t represents numbers from 9 to 12 and

u represents numbers from 7 to 9.

The above formulae give a general definition of the alkanol alkoxylates. These substances are mixtures of substances of the type indicated having different chain lengths. For the indices, therefore, average values are calculated which can also differ from integers.

By way of example, an alkanol alkoxylate of the formula (Id) may be mentioned, in which

t represents the average value 10.5 and

u represents the average value 8.4.

The alkanol alkoxylates of the formulae indicated are known or can be prepared by known methods (cf. WO 98-35 553, WO 00-35 278 and EP-A 0 681 865).

Possible vegetable oils are all oils which can customarily be employed in agrochemical agents and can be obtained from plants. By way of example, sunflower oil, rapeseed oil, olive oil, castor oil, colza oil, maize germ oil, cottonseed oil and soya bean oil may be mentioned.

The oil-based suspension concentrates according to the invention contain at least one non-ionic surfactant or dispersing aid and/or at least one anionic surfactant or dispersing aid.

Suitable non-ionic surfactants or dispersing aids are all substances of this type which can customarily be employed in agrochemical agents. Preferably, polyethylene oxide- polypropylene oxide block copolymers, polyethylene glycol ethers of linear alcohols, reaction products of fatty acids with ethylene oxide and/or propylene oxide, furthermore polyvinyl alcohol, polyvinylpyrrolidone, copolymers of polyvinyl alcohol and polyvinylpyrrolidone, and copolymers of (meth)acrylic acid and (meth)-acrylic acid esters, furthermore alkyl ethoxylates and alkylaryl ethoxylates, which can be optionally phosphated and optionally neutralized with bases, where sorbitol ethoxylates may be mentioned by way of example, and polyoxyalkylenamine derivatives may be mentioned.

Possible anionic surfactants are all substances of this type which can customarily be employed in agrochemical agents. Alkali metal and alkaline earth metal salts of alkylsulphonic acids or alkylarylsulphonic acids are preferred.

A further preferred group of anionic surfactants or dispersing aids are salts of poly-styrenesulphonic acids, salts of polyvinylsulphonic acids, salts of naphthalene-sulphonic acid-formaldehyde condensation products, salts of condensation products of naphthalenesulphonic acid, phenolsulphonic acid and formaldehyde, and salts of lignosulphoric acid, which are not very soluble in vegetable oil.

Suitable additives which can be contained in the formulations according to the invention are emulsifiers, antifoam agents, preservatives, antioxidants, colourants and inert filling materials.

Preferred emulsifiers are ethoxylated nonylphenols, reaction products of alkylphenols with ethylene oxide and/or propylene oxide, ethoxylated arylalkylphenols, furthermore ethoxylated and propoxylated arylalkylphenols, and sulphated or phosphated arylalkyl ethoxylates or -ethoxy-propoxylates, where sorbitan derivatives, such as polyethylene oxide-sorbitan fatty acid esters and sorbitan fatty acid esters, may be mentioned by way of example.

Suitable antifoam substances are all substances which can customarily be employed in agrochemical agents for this purpose. Silicone oils and magnesium stearate are preferred.

Possible preservatives are all substances which can customarily be employed in agrochemical agents for this purpose. Examples which may be mentioned are Preventol® (Bayer AG) and Proxel®.

Suitable antioxidants are all substances which can customarily be employed in agrochemical agents for this purpose. Butylhydroxytoluene is preferred.

Possible colourants are all substances which can customarily be employed in agrochemical agents for this purpose. Titanium dioxide, carbon black, zinc oxide and blue pigments, and Permanent Red FGR may be mentioned by way of example.

Suitable inert filling materials are all substances which can customarily be employed in agrochemical agents for this purpose, and which do not function as thickening agents. Inorganic particles, such as carbonates, silicates and oxides and also organic substances, such as urea-formaldehyde condensates, are preferred. Kaolin, rutile, silica (“highly disperse silicic acid”), silica gels, and natural and synthetic silicates, moreover talc, may be mentioned by way of example.

The content of the individual components can be varied within a wide range in the oil-based suspension concentrates according to the invention. Thus, the concentrations

of agrochemical active compounds are in general between 5 and 30% by weight, preferably between 10 and 25% by weight,

of penetration promoter are in general between 5 and 55% by weight, preferably between 15 and 40% by weight,

of vegetable oil are in general between 15 and 55% by weight, preferably between 20 and 50% by weight,

of surfactants or dispersing aids are in general between 2.5 and 30% by weight, preferably between 5.0 and 25% by weight and

of additives are in general between 0 and 25% by weight, preferably between 0 and 20% by weight.

The oil-based suspension concentrates according to the invention are prepared by mixing the components with one another in the ratios desired in each case. The sequence in which the constituents are blended with one another is arbitrary. Expediently, the solid components are employed in finely ground state. However, it is also possible firstly to subject the suspension resulting after the blending of the constituents to a coarse grinding and then to a fine grinding so that the average particle size is below 20 μm. Suspension concentrates are preferred in which the solid particles have an average particle size of between 1 and 10 μm.

The temperatures can be varied within a certain range when carrying out the process according to the invention. The process is in general carried out at temperatures between 10° C. and 60° C., preferably between 15° C. and 40° C.

For carrying out the process according to the invention, customary mixing and grinding equipment is suitable which is employed for the preparation of agrochemical formulations.

The oil-based suspension concentrates according to the invention are formulations which remain stable even after relatively long storage at elevated temperatures or in the cold, since no crystal growth is observed. They can be converted into homogeneous spray liquids by dilution with water. These spray liquids are used according to customary methods, i.e., for example, by spraying, watering or injecting.

The application rate of the oil-based suspension concentrates according to the invention can be varied within a relatively wide range. It depends on the particular agrochemical active compounds and on their content in the formulations.

With the aid of the oil-based suspension concentrates according to the invention, agrochemical active compounds can be applied to plants and/or their habitat in a particularly advantageous manner. The agrochemical active compounds contained in this case display a better biological activity than on application in the form of the corresponding conventional formulations.

The invention is illustrated by the following examples.

### PREPARATION EXAMPLES

### Example 1

For the preparation of a suspension concentrate

48.4 g of thiacloprid

45.6 g of a mixture of alkylarylsulphonate, ethylhexanol and alkanol ethoxylate

40.0 g of polyoxyethylene sorbitol oleate,

0.4 g of silicone oil and

0.8 g of butylhydroxytoluene

are added with stirring at room temperature to a mixture of

88.0 g of 2-ethyl-hexyl alkoxylate of the formula

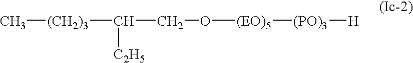

in which

EO represents —CH₂—CH₂—O—,

PO represents

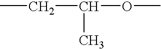

and the numbers 5 and 3 are average values,

and

176.8 g of sunflower oil.

After addition is complete, the mixture is stirred at room temperature for a further 10 minutes. The homogeneous suspension resulting in the course of this is firstly subjected to a coarse grinding and then to a fine grinding so that a suspension is obtained in which 90% of the solid particles have a particle size of below 6 ptm.

### Example 2

For the preparation of a suspension concentrate

78.2 g of thiacloprid

40.0 g of a mixture of calcium alkylarylsulphonate, alkylphenol ethoxylate and naphtha solution

40.0 g of polyoxyethylene sorbitol oleate

0.4 g of silicone oil and

0.8 g of butylhydroxytoluene

are added with stirring at room temperature to a mixture of

80.0 g of 2-ethyl-hexyl alkoxylate of the formula (Ic-2) and

160.6 g of sunflower oil.

After addition is complete, the mixture is stirred at room temperature for a further 10 minutes. The homogeneous suspension resulting in the course of this is firstly subjected to a coarse grinding and then to a fine grinding so that a suspension is obtained in which 90% of the solid particles have a particle size of below 6 μm.

### Example 3

For the preparation of a suspension concentrate

50.4 g of thiacloprid

27.5 g of a mixture of alkylarylsulphonate and ethylhexanol

5.25 g of singly branched alkanol ethoxylate having on average 15 ethylene oxide groups

25.0 g of polyoxyethylene sorbitol oleate

0.25 g of silicone oil and

0.5 g of butylhydroxytoluene

are added with stirring at room temperature to a mixture of

50.0 g of 2-ethyl-hexyl alkoxylate of the formula (Ic-2) and

91.1 g of sunflower oil.

After addition is complete, the mixture is stirred at room temperature for a further 10 minutes. The homogeneous suspension resulting in the course of this is firstly subjected to a coarse grinding and then to a fine grinding so that a suspension is obtained in which 90% of the solid particles have a particle size of below 6 μm.

### Example 4

For the preparation of a suspension concentrate

49.4 g of thiacloprid

23.75 g of a mixture of alkylarylsulphonate and ethylhexanol

4.5 g of singly branched alkanol ethoxylate having on average 15 ethylene oxide groups

25.0 g of polyoxyethylene sorbitol oleate

0.25 g of silicone oil and

0.5 g of butylhydroxytoluene

are added with stirring at room temperature to a mixture of

50.0 g of 2-ethyl-hexyl alkoxylate of the formula (Ic-2) and

96.6 g of sunflower oil.

After addition is complete, the mixture is stirred at room temperature for a further 10 minutes. The homogeneous suspension resulting in the course of this is firstly subjected to a coarse grinding and then to a fine grinding so that a suspension is obtained in which 90% of the solids particles have a particle size of below 6 μm.

### Example 5

For the preparation of a suspension concentrate

692.54 g of thiacloprid

300.0 g of a mixture of alkylarylsulphonate, alkanol ethoxylate and naphtha solution

300.0 g of polyoxyethylene sorbitol oleate

3.0 g of silicone oil and

6.0 g of butylhydroxytoluene

are added with stirring at room temperature to a mixture of

600.0 g of 2-ethyl-hexyl alkoxylate of the formula (Ic-2) and

1098.46 g of sunflower oil.

After addition is complete, the mixture is stirred at room temperature for a further 10 minutes. The homogeneous suspension resulting in the course of this is firstly subjected to a coarse grinding and then to a fine grinding so that a suspension is obtained in which 90% of the solid particles have a particle size of below 6 μm.

### Example 6

For the preparation of a suspension concentrate

577.1 g of thiacloprid

327.5 g of a mixture of alkylarylsulphonate, ethylhexanol and alkanolethoxylate

250.0 g of polyoxyethylene sorbitol oleate

2.5 g of silicone oil and

5.0 g of butylhydroxytoluene

are added with stirring at room temperature to a mixture of

500.0 g of 2-ethyl-hexyl alkoxylate of the formula (Ic-2) and

837.9 g of sunflower oil.

After addition is complete, the mixture is stirred at room temperature for a further 10 minutes. The homogeneous suspension resulting in the course of this is firstly subjected to a coarse grinding and then to a fine grinding so that a suspension is obtained in which 90% of the solid particles have a particle size of below 6 μm.

### Example 7

For the preparation of a suspension concentrate

44.4 g of thiacloprid

5.6 g of β-cyfluthrin

49.7 g of a mixture of alkylarylsulphonate, ethylhexanol and alkanol ethoxylate

44.0 g of polyoxyethylene sorbitol oleate

0.4 g of silicone oil and

0.8 g of butylhydroxytoluene

are added with stirring at room temperature to a mixture of

101.3 g of 2-ethyl-hexyl alkoxylate of the formula (Ic-2) and

193.8 g of sunflower oil.

After addition is complete, the mixture is stirred at room temperature for a further 10 minutes. The homogeneous suspension resulting in the course of this is firstly subjected to a coarse grinding and then to a fine grinding so that a suspension is obtained in which 90% of the solid particles have a particle size of below 6 μm.

### Example 8

For the preparation of a suspension concentrate

121.0 g of thiacloprid

15.2 g of β-cycluthrin

78.6 g of a mixture of alkylarylsulphonate, ethylhexanol and alkanol ethoxylate

60.0 g of polyoxyethylene sorbitol oleate

0.6 g of silicone oil and

1.2 g of butylhydroxytoluene

are added with stirring at room temperature to a mixture of

120.0 g of 2-ethyl-hexyl alkoxylate of the formula (Ic-2) and

203.4 g of sunflower oil.

After addition is complete, the mixture is stirred at room temperature for a further 10 minutes. The homogeneous suspension resulting in the course of this is firstly subjected to a coarse grinding and then to a fine grinding so that a suspension is obtained in which 90% of the solid particles have a particle size of below 6 μm.

### Example 9

For the preparation of a suspension concentrate

138.5 g of thiacloprid,

60.0 g of polyoxyethylene sorbitol oleate

12.0 g of polystyrene-acrylic acid copolymer

48.0 g of polyoxyethylene fatty acid glyceride

0.6 g of silicone oil and

1.2 g of butylhydroxytoluene

are added with stirring at room temperature to a mixture of

120.0 g of alkanol alkoxylate of the formula

R—O-(EO)₃—(PO)₆—H

in which

R represents alkyl having 12 to 14 carbon atoms,

EO represents —CH₂—CH₂—O,

PO represents

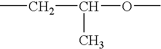

and the numbers 3 and 6 are average values, and

219.7 g of rapeseed oil.

After addition is complete, the mixture is stirred at room temperature for a further 10 minutes. The homogeneous suspension resulting in the course of this is firstly subjected to a coarse grinding and then to a fine grinding so that a suspension is obtained in which 90% of the solid particles have a particle size of below 6 μm.

### Use Examples

### Example I

Stability Test

For the determination of the stability, 100 g in each case of a suspension concentrate of the composition described in Example 2 are stored for a number of weeks at

−10° C.,

room temperature,

+30° C.,

+40° C.

+54° C.

alternating temperatures (6 hours at −15° C., then 6 hours at +30° C.).

The experimental results are compiled in the following tables.

TABLE Ia
Storage at −10° C.

| | after | | | | |
|---|---|---|---|---|---|
| | 2 | 4 | 8 | 16 | 26 |
| | weeks | weeks | weeks | weeks | weeks |
| Sediment vol-ume | | | | | 99 |
| in % *⁾ | | | | | |
| Sediment | | | | | none |
| Redispers-ability | | | | | good |
| Particle size **⁾ in μm | | | | | 5.35 |
| Content of active | | | | | 19.8 |
| compound in % | | | | | |

*⁾ Sediment volume = volume of the sediment phase in relation to the total volume of the sample.
**⁾ The average particle size which 90% of the solid particles in the oil phase have was measured.

TABLE Ib
Storage at room temperature

| | after | | | | |
|---|---|---|---|---|---|
| | 2 | 4 | 8 | 16 | 26 |
| | weeks | weeks | weeks | weeks | weeks |
| Sediment volume in | | | 97 | | 89 |
| % *⁾ | | | | | |
| Sediment | | | none | | none |
| Redispers-ability | | | good | | good |
| Particle size **⁾ in μm | | | 5.31 | | 5.86 |
| Content of active | | | 20.1 | | 19.6 |
| com-pound in % | | | | | |

*⁾ Sediment volume = volume of the sediment phase in relation to the total volume of the sample.
**⁾ The average particle size which 90% of the solid particles in the oil phase have was measured.

TABLE Ic
Storage at +30° C.

| | after | | | | |
|---|---|---|---|---|---|
| | 2 | 4 | 8 | 16 | 26 |
| | weeks | weeks | weeks | weeks | weeks |
| Sediment volume in | | | 94 | | 84 |
| % *⁾ | | | | | |
| Sediment | | | none | | none |
| Redispers-ability | | | good | | good |
| Particle size **⁾ in μm | | | 6.57 | | 5.74 |
| Content of active | | | 20.0 | | 19.8 |
| com-pound in % | | | | | |

*⁾ Sediment volume = volume of the sediment phase in relation to the total volume of the sample.
**⁾ The average particle size which 90% of the solid particles in the oil phase have was measured.

TABLE Id
Storage at +40° C.

| | after | | | | |
|---|---|---|---|---|---|
| | 2 | 4 | 8 | 16 | 26 |
| | weeks | weeks | weeks | weeks | weeks |
| Sediment volume in | | 93 | 92 | 87 | 82 |
| % *⁾ | | | | | |
| Sediment | | none | none | none | none |
| Redispers-ability | | good | good | good | good |
| Particle size **⁾ in μm | | 6.01 | 6.29 | 7.08 | 6.4 |
| Content of active | | 20.2 | 19.3 | 20.1 | 19.7 |
| com-pound in % | | | | | |

*⁾ Sediment volume = volume of the sediment phase in relation to the total volume of the sample.
**⁾ The average particle size which 90% of the solid particles in the oil phase have was measured.

TABLE Ie
Storage at +54° C.

| | after | | | | |
|---|---|---|---|---|---|
| | 2 | 4 | 8 | 16 | 26 |
| | weeks | weeks | weeks | weeks | weeks |
| Sediment volume | 96 | 89 | 83 | | |
| in % *⁾ | | | | | |
| Sediment | none | none | none | | |
| Redispers-ability | good | good | good | | |
| Particle size **⁾ in μm | | 8.81 | 6.61 | | |
| Content of active | 20.1 | 20.0 | 20.1 | | |
| com-pound in % | | | | | |

*⁾ Sediment volume = volume of the sediment phase in relation to the total volume of the sample.
**⁾ The average particle size which 90% of the solid particles in the oil phase have was measured.

TABLE If
Storage at alternating temperatures

| | after | | | | |
|---|---|---|---|---|---|
| | 2 | 4 | 8 | 16 | 26 |
| | weeks | weeks | weeks | weeks | weeks |
| Sediment volume | | 98 | 99 | | |
| in % *⁾ | | | | | |
| Sediment | | none | none | | |
| Redispers-ability | | good | good | | |
| Particle size **⁾ in μm | | 5.62 | 6.17 | | |
| Content of active | | 20.0 | 19.8 | | |
| com-pound in % | | | | | |

*⁾ Sediment volume = volume of the sediment phase in relation to the total volume of the sample.
**⁾ The average particle size which 90% of the solid particles in the oil phase have was measured.

### Example II

Penetration Test

In this test, the penetration of active compounds through enzymatically isolated cuticles of apple tree leaves was measured.

Leaves were used which were cut off in the fully developed state of apple trees of the variety Golden Delicious. The cuticles were isolated by

firstly filling, by means of vacuum infiltration with a pectinase solution (0.2 to 2% strength) buffered to a pH of between 3 and 4, leaf discs which had been marked on the bottom with dye and punched out,

then adding sodium azide and

allowing the leaf discs treated in this way to stand until the disintegration of the original leaf structure and the detachment of the non-cellular cuticles.

After this, only the leaf cuticles of the tops of the leaves which were free from stomata and hairs were used further. They were washed a number of times alternately with water and a buffer solution of pH 7. The clean cuticles obtained were finally mounted on small Teflon plates and smoothed out and dried using a gentle jet of air.

In the next step, the cuticle membranes thus obtained were placed into diffusion cells (=transport chambers) of stainless steel for membrane transport investigations. For this, using tweezers the cuticles were placed centrally on the edges of the diffusion cells coated with silicone grease and sealed using a likewise greased ring. The arrangement had been chosen such that the morphological outer side of the cuticles was directed outwards, i.e. to the air, while the original inner side was facing the interior of the diffusion cell. The diffusion cells were filled with water or with a mixture of water and solvent.

For determination of the penetration, 9 μl in each case of a spray liquor of the composition mentioned below was applied to the outer side of a cuticle.

Spray Liquor A

0.2 g of thiacloprid

0.4 g of sunflower oil

0.4 g of formulating aids in 1 litre of water.

Spray Liquor B

0.2 g of thiacloprid

0.5 g of 2-ethyl-hexyl alkoxylate of the formula (Ic-2)

0.3 g of formulating aids in 1 litre of water.

Spray Liquor C

0.2 g of thiacloprid

0.4 g of sunflower oil

0.2 g of 2-ethyl-hexyl alkoxylate of the formula (Ic-2)

0.2 g of formulating aids in 1 litre of water.

Spray Liquor D

0.2 g of thiacloprid

0.3 g of formulating aids in 1 litre of water,

(prepared from commercially available suspension concentrate by diluting with water).

CIPAC water was in each case used in the spray liquors.

After the application of the spray liquors, the water was allowed to evaporate in each case, then the chambers were in each case turned and placed in thermostatted baths, a saturated aqueous calcium nitrate 4-hydrate solution in each case being located under the outer side of the cuticles. The penetration commencing therefore took place at a relative humidity of 56% and a set temperature of 25° C. Samples were removed at regular intervals using a syringe and investigated by means of HPLC for the content of penetrated active compound.

The experimental results can be seen from the following table. The numbers stated are average values of 8 measurements.

TABLE II

| | Active compound | | |
|---|---|---|---|
| | penetration in | | |
| | % after | | |
| | 5 h | 10 h | 20 h |
| A | 1 | 3 | 4 |
| B | 10 | 16 | 20 |
| C | 6 | 17 | 40 |
| D | | | 1 |

1. Oil-based suspension concentrates, consisting of
at least one agrochemical active compound which is solid at room temperature,
at least one penetration promoter,
at least one vegetable oil,
at least one non-ionic surfactant or dispersing aid and/or at least one anionic surfactant or dispersing aid and
optionally one or more additives from the groups consisting of the emulsifying agents, the antifoam agents, the preservatives, the antioxidants, the colourants and/or the inert filling materials.

2. Suspension concentrates according to claim 1, characterized in that the agrochemical active compound contained is a fungicide, bactericide, insecticide, acaricide, nematicide, molluscicide, herbicide, plant growth regulator, plant nutrient and/or a repellent.

3. Suspension concentrates according to claim 1, characterized in that the agrochemical active compound contained is thiacloprid.

4. Suspension concentrates according to claim 1, characterized in that the agrochemical active compounds contained are thiacloprid and β-cyfluthrin.

5. Suspension concentrates according to claim 1, characterized in that the penetration promoter contained is at least one alkanol alkoxylate of the formula
R—O-(-AO)ₘH (I)
in which
R represents straight-chain or branched alkyl having 4 to 20 carbon atoms,
AO represents an ethylene oxide radical, a propylene oxide radical, a butylene oxide radical or mixtures of ethylene oxide and propylene oxide radicals or butylene oxide radicals and
m represents numbers from 2 to 30.

6. Suspension concentrates according to claim 1, characterized in that the penetration promoter contained is 2-ethyl-hexyl alkoxylate of the formula 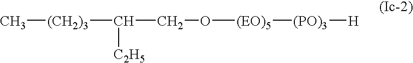
in which
EO represents —CH₂—CH₂—O—,
PO represents 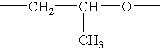
and the numbers 5 and 3 are average values.

7. Suspension concentrates according to claim 1, characterized in that the vegetable oil contained is sunflower oil, rapeseed oil, olive oil, castor oil, colza oil, maize germ oil, cottonseed oil and/or soya bean oil.

8. Suspension concentrates according to claim 1, characterized in that the content
of agrochemical active compounds is between 5 and 30% by weight,
of penetration promoter is between 5 and 55% by weight,
of vegetable oil is between 15 and 55% by weight,
of surfactants or dispersing aids is between 2.5 and 30% by weight and
of additives is between 0 and 25% by weight.

9. Process for the preparation of suspension concentrates according to claim 1, characterized in that
at least one agrochemical active compound which is solid at room temperature,
at least one penetration promoter,
at least one vegetable oil,
at least one non-ionic surfactant or dispersing aid and/or at least one anionic surfactant or dispersing aid and
optionally one or more additives from the groups consisting of the emulsifying agents, the antifoam agents, the preservatives, the antioxidants, the colourants and/or the inert filling materials
are mixed with one another and the resulting suspension is optionally subsequently ground.

10. Use of suspension concentrates according to claim 1 for the application of the agrochemical active compounds contained to plants and/or their habitat.
